(19) United States
(12) Patent Application Publication
(10) Pub. No.: US 2020/0234649 A1
(43) Pub. Date: Jul. 23, 2020

(54) ARRAY SUBSTRATES AND DRIVING METHODS THEREOF, AND DISPLAY PANELS

(71) Applicant: KUNSHAN GO-VISIONOX OPTO-ELECTRONICS CO., LTD., Kunshan (CN)

(72) Inventors: Longfei FAN, Kunshan (CN); Hui ZHU, Kunshan (CN)

(21) Appl. No.: 16/838,040

(22) Filed: Apr. 2, 2020

Related U.S. Application Data
(63) Continuation of application No. PCT/CN2019/079144, filed on Mar. 21, 2019.

(30) Foreign Application Priority Data
Sep. 28, 2018 (CN) 201811137492.3

(51) Int. Cl. G09G 3/3266; G09G 3/3291

(52) U.S. Cl. CPC G09G 3/3266; G09G 2330/028; G09G 2310/0278; G09G 3/3291

(57) ABSTRACT

The present disclosure relates to an array substrate, including a display area and a non-display area arranged around the display area. The display area includes a plurality of pixel circuits arranged in an array and a first signal line connecting to the pixel circuits. The non-display area includes at least one common circuit and a data driving chip. Each of the common circuits is connected to the pixel circuit through the first signal line, and is configured to provide an initialization signal and a data signal for the pixel circuit. The data driving chip is connected to the common circuit through a second signal line and a third signal line.

### CROSS-REFERENCES TO RELATED APPLICATIONS

This application is a continuation application for International Application PCT/CN2019/079144, filed on Mar. 21, 2019, which claims priority to Chinese Patent Application No. 201811137492.3, filed with the Chinese Patent Office on Sep. 28, 2018 and entitled “ARRAY SUBSTRATE AND DISPLAY PANEL”, the contents of both applications are incorporated by reference herein for all purposes.

### TECHNICAL FIELD

The present disclosure relates to the technical field of display technologies.

### BACKGROUND

Because of its advantages of high contrast, low power consumption, wide viewing angle and fast reaction speed, organic emitting display panels are increasingly used in display field. An organic emitting display panel contains pixel circuits arranged in arrays. Generally, in order to achieve high resolution, the size of the pixel circuit is reduced, and the data signal line and the initialization signal line are combined, that is, the data signal and the initialization signal are inputted to the pixel circuit through the same signal line.

### SUMMARY

According to various embodiments disclosed in the disclosure, an array substrate and driving method thereof, and a display panel are provided.

An array substrate is provided including a display area and a non-display area arranged around the display area. The display area includes a plurality of pixel circuits arranged in an array and a first signal line connecting to the pixel circuits. The non-display area includes at least one common circuit and a data driving chip. Each of the common circuits is connected to the pixel circuit through the first signal line, and is configured to provide an initialization signal and a data signal for the pixel circuit. The data driving chip is connected to the common circuit through a second signal line and a third signal line. The data driving chip provides the initialization signal to the common circuit through the second signal line, the common circuit receives the initialization signal and initializes the pixel circuit through the first signal line, and the data driving chip provides the data signal to the common circuit through the third signal line, and the common circuit receives the data signal and writes data to the pixel circuit through the first signal line.

In an embodiment, the common circuit includes an initialization circuit and a data writing circuit. The initialization circuit is connected to the data driving chip through the second signal line, and is configured to receive an initialization signal outputted by the data driving chip and transmit the initialization signal to the pixel circuit through the first signal line. The data writing circuit is connected to the data driving chip through the third signal line, and is configured to receive the data signal outputted by the data driving chip and transmit the data signal to the pixel circuit through the first signal line.

In an embodiment, the non-display region further includes a scan driving chip and a first control signal line and a second control signal line connected to the scan driving chip; the scan driving chip provides a first control signal to the initialization circuit through the first control signal line, such that the initialization circuit provides the initialization signal to the pixel circuit when the first control signal is active; the scan driving chip provides a second control signal to the data writing circuit through the second control signal line, such that the data writing circuit provides the data signal to the pixel circuit when the second control signal is active.

In an embodiment, the scan driving chip is connected to the pixel circuit through a scan signal line, and configured to provide a scan signal to the pixel circuit.

In an embodiment, the array substrate further includes a light emitting control chip connected to the pixel circuit through a light emitting control signal line, configured to provide a light emitting control signal for the pixel circuit.

In an embodiment, the initialization circuit includes an initialization transistor; a control end of the initialization transistor is connected to the scan driving chip through the first control signal line, a first pole of the initialization transistor is connected to the pixel circuit through the first signal line, and a second pole of the initialization transistor is connected to the data driving chip through the second signal line; and the data writing circuit includes a data writing transistor, a control end of the data writing transistor is connected to the scan driving chip through the second control signal line, a first pole of the data writing transistor is connected to the pixel circuit through the first signal line, and a second pole of the data writing transistor is connected to the data driving chip through the second signal line.

In an embodiment, the pixel circuit includes a first transistor, a second transistor, a third transistor, a fourth transistor, a fifth transistor, a sixth transistor, a capacitor, and a light emitting diode; a control end of the first transistor is connected to a first pole plate of the capacitor, a second pole of the second transistor, and a first pole of the sixth transistor, a first pole of the first transistor is connected to the first power source, and a second pole of the first transistor is connected to a first pole of the second transistor and a first pole of the third transistor; a control end of the second transistor is connected to a second scanning signal line; a control end of the third transistor is connected to a light emitting control signal line, a second pole of the third transistor is connected to a first pole of the fifth transistor and an anode of the light emitting diode, and a cathode of the light emitting diode is connected to a second power source; a control end of the fifth transistor is respectively connected to a control end of the sixth transistor and a first scanning signal line, and a second pole of the fifth transistor is connected to a second pole of the sixth transistor, a second pole of the fourth transistor, the first pole of the initialization transistor, and the first pole of the data writing transistor; and a control end of the fourth transistor is connected to a third scanning signal line, and a first pole of the fourth transistor is connected to a second pole plate of the capacitor.

In an embodiment, when the first control signal and the first scan signal are active simultaneously, the first control signal controls the initialization transistor to be switched on, the first scan signal controls the fifth transistor and the sixth transistor to be switched on, and the initialization signal initializes the first pole plate of the capacitor, the control end of the first transistor, and the anode of the light emitting diode.

In an embodiment, a voltage of the initialization signal is lower than a supply voltage of the second power source.

In an embodiment, when the third scan signal and the second control signal are active simultaneously, the third scan signal controls the fourth transistor to be switched on, the second control signal controls the data writing transistor to be switched on, and the data signal is written to the second pole of the capacitor through the data writing transistor and the fourth transistor.

In an embodiment, when the third scan signal and the first control signal are active simultaneously, the third scan signal controls the fourth transistor to be switched on, the first control signal controls the initialization transistor to be switched on, and the initialization signal is applied to the control end of the first transistor through the capacitor to compensate a supply voltage provided by the first power source.

In an embodiment, when the light emitting control signal is active, the light emitting control signal controls the third transistor to be switched on and the light emitting diode emits light.

A display panel is provided including the foregoing substrate array.

A method for driving the foregoing array substrate includes:

providing, through a data driving chip, an initialization signal to a common circuit through a second signal line, and receiving, through the common circuit, the initialization signal and initializing the pixel circuit through a first signal line; and providing, through the data driving chip, a data signal to the common circuit through a third signal line, and receiving, through the common circuit, the data signal and writing data to the pixel circuit through the first signal line.

In an embodiment, the common circuit includes an initialization circuit and a data writing circuit, the initialization circuit is connected to the data driving chip through the second signal line, and the data writing circuit is connected to the data driving chip through the third signal line, and the method further includes: receiving, through the initialization circuit, an initialization signal outputted by the data driving chip and transmitting, through the first signal line, the initialization signal to the pixel circuit; and receiving, through the data writing circuit, the data signal outputted by the data driving chip and transmitting the data signal to the pixel circuit through the first signal line.

In an embodiment, the non-display region further includes a scan driving chip and a first control signal line and a second control signal line that are connected to the scan driving chip, and the method further includes: providing, through the scan driving chip, a first control signal to the initialization circuit through the first control signal line, and providing through the initialization circuit, the initialization signal to the pixel circuit when the first control signal is active; and providing, through the scan driving chip, a second control signal to the data writing circuit through the second control signal line, and providing, through the data writing circuit, the data signal to the pixel circuit when the second control signal is active.

In an embodiment, the scanning driving chip is connected to the pixel circuit through a scanning signal line, and the method further includes: providing, through the scan driving chip, a scan signal to the pixel circuit through a scan signal line.

In an embodiment, the array substrate further includes a light emitting control chip connected to the pixel circuit through a light emitting control signal line, and the method further includes: providing, through the light emitting control chip, a light emitting control signal for the pixel circuit through a light emitting control signal line.

The foregoing array substrate and display panel are provided with a common circuit in the non-display area. The data driving chip is connected to the common circuit through the second signal line and the third signal line. In addition, the data driving chip outputs different signals at different time periods, and can provide initialization signals to the common circuit through the second signal line and provide data signals to the common circuit through the third signal line. The common circuit outputs the received signal to the pixel circuit through the first signal line. The present disclosure uses different tracing to output different signals, so as to facilitate the control of the data driving chip, and addresses the problem of display failure caused due to outputting different signals through the same tracing. Meanwhile, in the display area, the common circuit transmits the data signal and the initialization signal respectively to the pixel circuit through the first signal line, that is, the data signal and the initialization signal share the same signal line in the display area, which reduces the density of the screen tracing, thus increasing the aperture rate and realizing the high resolution display.

### BRIEF DESCRIPTION OF THE DRAWINGS

FIG. 1 is a schematic diagram of an array substrate according to an embodiment of the disclosure;

FIG. 2 is a schematic diagram of a pixel circuit according to an embodiment of the disclosure;

FIG. 3 is a sequence signal chart of a pixel circuit according to an embodiment of the disclosure.

### DETAILED DESCRIPTION OF THE INVENTION

The applicant finds that the driving chip outputs different signals through the same signal line to control the operation of the pixel circuit, which leads to the failure of display panel.

In order to make the foregoing objects, features and advantages of the present disclosure more obvious and easy to understand, the following describes in detail the specific embodiments of the present disclosure with reference to the accompanying drawings. Many specific details are set forth in the following description to facilitate full understanding of the present disclosure. However, the present disclosure can be implemented in many different manners from those described herein. A person skilled in the art may make similar improvements without departing from the connotation of the present disclosure. Therefore, the present disclosure is not limited to the specific embodiments disclosed below.

It should be noted that when a component is referred to as to be “arranged on” another component, it can be directly on another component or it can be a centered component. When one component is considered to be “connected” to another component, it can be connected directly to another component or may exist simultaneously. The terms “vertical”, “horizontal”, “left”, “right” and similar expressions used in this paper are for illustrative purposes only and do not mean the only way to implement them.

An embodiment of the disclosure provides an array substrate, which includes a display area 100 and a non-display area 200 arranged around the display area 100. The display area 100 includes pixel circuits 110 arranged in an array and a first signal line 120 connected to the pixel circuit 110. The non-display area 200 includes common circuits 210, each of common circuits 210 is connected to the pixel circuit 110 through the first signal line 120, to provide an initialization signal and a data signal for the pixel circuits 110. The non-display area 200 further includes a data driving chip 220 connected to the common circuit 210 through a second signal line 221 and a third signal line 222. Further, the data driving chip 220 provides an initialization signal to the common circuit 210 through the second signal line 221. After receiving the initialization signal, the common circuit 210 initializes the pixel circuit 110 through the first signal line 120. The data driving chip 220 provides the data signal to the common circuit 210 through the third signal line 222. After receiving the data signal, the common circuit 210 writes data to the pixel circuit 110 through the first signal line 120. In the embodiment, the data driving chip 220 may output different signals at different time periods, and transmit the signals to the common circuit 210 through the second signal line 221 or the third signal line 222, respectively. It should be noted that the first signal line 120 is located in the display area 100, the second signal line 221 and the third signal line 222 are located in the non-display area 200.

The array substrate provided by the foregoing embodiment is provided with a common circuit 210 in the non-display area 200. The data driving chip 220 is connected to the common circuit 210 through the second signal line 221 and the third signal line 222. In addition, the data driving chip 220 outputs different signals at different time periods, and can provide the initialization signal to the common circuit 210 through the second signal line 221 and the data signal to the common circuit 210 through the third signal line 222. The common circuit 210 outputs the received signal to the pixel circuit 110 through the first signal line 120. In the embodiment, different tracings are configured to output different signals, so as to facilitate the control of the data driving chip 220. This addresses the problem that display failure may be caused due to outputting different signals through the same tracing. Simultaneously, in the display area 100, the common circuit 210 transmits the data signal and the initialization signal to the pixel circuit 110 through the first signal line 120 at different time periods, that is, the data signal and the initialization signal share one signal line in the display area 100, thereby reducing the density of the screen tracing, thereby increasing the aperture rate and realizing high resolution display.

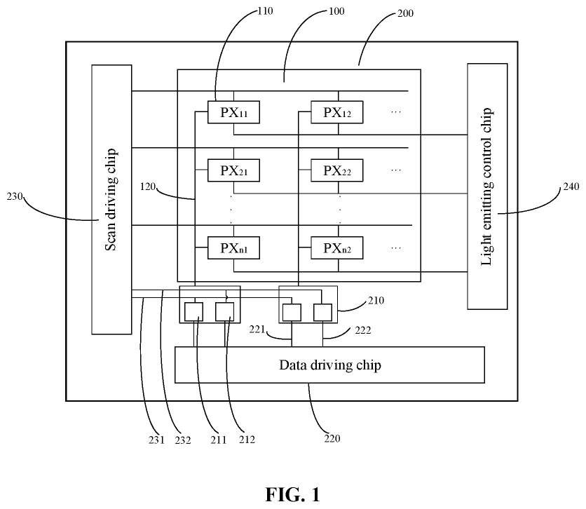

In an embodiment, referring to FIG. 1, the common circuit 210 includes an initialization circuit 211 and a data writing circuit 212. The initialization circuit 211 is connected to the data driving chip 220 through the second signal line 221, and is configured to receive the initialization signal outputted by the data driving chip 220, and transmit the initialization signal to each column of the pixel circuit 110 through the first signal line 120. The data writing circuit 212 is connected to the data driving chip 220 through the third signal line 222, and is configured to receive the data signal outputted by the data driving chip 220 and transmit the data signal to each column of the pixel circuit 110 through the first signal line 120.

In the present embodiment, the output ends of each group of the initialization circuit 211 and the data writing circuit 212 are jointly connected to the same first signal line 120, and are connected to a column of pixel units through the first signal line 120. The initialization circuit 211 and the data writing circuit 212 operate at different time periods, respectively. When the initialization circuit 211 operates, the data writing circuit 212 does not operate, and the initialization circuit 211 receives the initialization signal and transmits the same to the pixel circuit 110 through the first signal line 120. When the data writing circuit 212 is operating, the initialization circuit 211 is not operating, and the data writing circuit 212 receives the data signal and transmits the same to the pixel circuit 110 through the first signal line 120. Therefore, in the embodiment, the data driving chip 220 transmits two types of signals through different signal lines, respectively, which facilitates control and reduces the risk of display failure caused due to outputting different signals through the same tracing. In one of the embodiments, the non-display area 200 of the array substrate further includes a scan driving chip 230, and a first control signal line 231 and a second control signal line 232 connected to the scan driving chip 230. The scan driving chip 230 provides the first control signal to the initialization circuit 211 through the first control signal line 231, such that the initialization circuit 211 provides the initialization signal to each column of the pixel circuit 110 when the first control signal is active. The scan driving chip 230 provides a second control signal to the data writing circuit 212 through the second control signal line 232, such that the data writing circuit 212 provides the data signal to each column of pixel circuit 110 when the second control signal is active.

Specifically, the scan driving chip 230 is connected to the control end of the initialization circuit 211 through the first control signal line 231, and is connected to the control end of the data writing circuit 212 through the second control signal line 232. The scan driving chip 230 outputs the first control signal and transmits the first control signal to the control end of the initialization circuit 211 through the first control signal line 231, such that the initialization circuit 211 is switched on, and the initialization signal may be transmitted to the pixel circuit 110 through the initialization circuit 211. The scan driving chip 230 outputs the second control signal and transmits the second control signal to the control end of the data writing circuit 212 through the second control signal line 232, such that the data writing circuit 212 is switched on, such that the data signal may be transmitted to the pixel circuit 110 through the data writing circuit 212 to write the data signal to the pixel circuit 110.

Further, the scan driving chip 230 is further connected to each row of pixel circuits 110 through a scan signal line, and configured to provide a scan signal for each row of pixel circuits 110. The array substrate further includes a light emitting control chip 240 connected to each row of pixel circuits 110 through a light emitting control signal line, and is configured to provide a light emitting control signal for each row of pixel circuits 110.

It should also be noted that in the above-described embodiment of FIG. 1, the plurality of pixel circuits 110 are arranged in arrays in a form of rows and columns, for example, PX₁₁, PX₂₁, . . . , PXₙₘ (not all shown in FIG. 1). However, it should be understood that, without departing from the inventive concept, the array arrangement of the pixel circuits 110 may be in other forms.

The data driving chip 220, the scanning driving chip 230 and the light emitting control chip 240 may be independent control chips, or may be integrated into the same control chip.

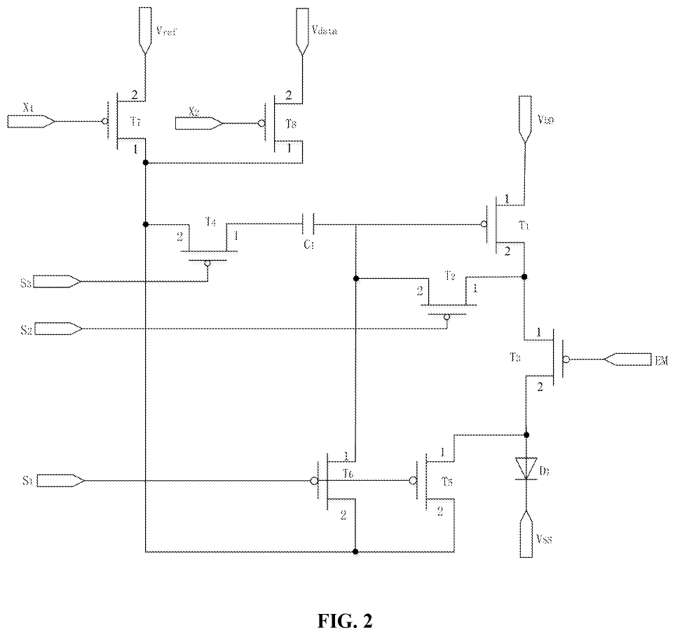

In an embodiment, referring to FIG. 2, the initialization circuit 211 includes an initialization transistor T₇, and the data writing circuit 212 includes a data writing transistor T₈. The control end of the initialization transistor T₇ is connected to the scan driving chip 230 through the first control signal line 231, the first pole of the initialization transistor T₇ is connected to the pixel circuit 110 through the first signal line 120, and the second pole of the initialization transistor T₇ is connected to the data driving chip 220 through the second signal line 221. The control end of the data writing transistor T₈ is connected to the scan driving chip 230 through the second control signal line 232, the first pole of the data writing transistor T₈ is connected to the pixel circuit 110 through the first signal line 120, and the second pole of the data writing transistor T₈ is connected to the data driving chip 220 through the second signal line 221. In alternative embodiments, the initialization circuit 211 and the data writing circuit 212 may also be other circuits capable of transmitting initialization signals and data signals, respectively, which is not limited hereto.

In the embodiment, both the initialization transistor T₇ and the data writing transistor T₈ may be P-type transistors. The first control signal and the second control signal outputted by the scan driving chip 230 may be low-level signals, and the first control signal and the second control signal may respectively control the initialization transistor T₇ and the data writing transistor T₈ to be switched on, such that the initialization signal or the data writing transistor T₇ or the data writing transistor T₈ may be written into the pixel circuit 110.

Referring to FIG. 2, in one of the embodiments, the pixel circuit 110 includes a first transistor T₁, a second transistor T₂, a third transistor T₃, a fourth transistor T₄, a fifth transistor T₅, a sixth transistor T₆, a capacitor C₁, and a light emitting diode D₁.

The control end of the first transistor T₁ is connected to the first pole of the capacitor C₁, the second pole of the second transistor T₂, and the first pole of the sixth transistor T₆. The first pole of the first transistor T₁ is connected to a first power source V_{DD}. And the second pole of the first transistor T₁ is connected to the first pole of the second transistor T₂ and the first pole of the third transistor T₃. The control end of the second transistor T₂ is connected to the second scanning signal line. The control end of the third transistor T₃ is connected to the light emitting control signal line, and the second pole of the third transistor T₃ is connected to the first pole of the fifth transistor T₅ and the D₁ anode of the light emitting diode. The cathode of the light emitting diode D₁ is connected to a second power source V_{SS}. The control end of the fifth transistor T₅ is connected to the control end of the sixth transistor T₆ and the first scanning signal line respectively, and the second pole of the fifth transistor T₅ is connected to the second pole of the sixth transistor T₆, the second pole of the fourth transistor T₄, the first pole of the initialization transistor T₇, and the first pole of the data writing transistor T₈. The control end of the fourth transistor T₄ is connected to the third scanning signal line, and the first pole of the fourth transistor T₄ is connected to the second pole plate of the capacitor C₁.

In the embodiment, the second transistor T₂, the third transistor T₃, the fourth transistor T₄, the fifth transistor T₅, and the sixth transistor T₆ of the pixel circuit 110 are all switching transistors, and the first transistor T₁ is a driving transistor. The capacitor C₁ is an energy storage capacitor and light emitting diode D₁ is an organic light-emitting diode (OLED). The transistors in the embodiment are all P-type transistors, and the control end is the gate of the transistor, the first pole is the source of the first transistor, and the second pole is the drain of the second transistor, a low level is applied to the control end of the transistor to switch on the transistor. Since the thin film transistor is a symmetrical device, the first and second poles are interchangeable. Of course, in other embodiments, the transistor may also be an N-type transistor, and when an N-type transistor is used as a transistor in the pixel circuit 110, a high level signal is inputted to the control end of the transistor to switch it on.

The first power source V_{DD} may be a positive voltage and is configured to provide a power source voltage to the first transistor T₁. The first transistor T₁ outputs current under the action of the first power source V_{DD}. The current flows into the light emitting diode D₁ to enable the light emitting diode D₁ to emit light. When the light emitting diode D₁ is emitting light, the current flows into the second power source V_{SS}, which may be a negative voltage.

In the circuit shown in FIG. 2, S₁ is the first scan signal transmitted by the first scan signal line, S₂ is the second scan signal transmitted by the second scan signal line, S₃ is the third scan signal transmitted by the third scan signal line, EM is the light emission control signal transmitted by the light emission control signal line, X₁ is the first control signal transmitted by the first control signal line 231, and X₂ is the second control signal transmitted by the second control signal line 232.

The first scanning signal line is connected to the control ends of the fifth transistor T₅ and the sixth transistor T₆, and is configured to input the first scanning signal to the control ends of the fifth transistor T₅ and the sixth transistor T₆ to control on and off of the fifth transistor T₅ and the sixth transistor T₆. The second scanning signal line is connected to the control end of the second transistor T₂, and is configured to input a second scanning signal to the control end of the second transistor T₂ to control the on and off of the second transistor T₂. The third scanning signal line is connected to the control end of the fourth transistor T₄, and is configured to input a third scanning signal to the control end of the fourth transistor T₄ to control the on and off of the fourth transistor T₄. The first control signal line 231 is connected to the control end of the initialization transistor T₇, and is configured to input a first control signal to the control end of the initialization transistor T₇ to control the on and off of the initialization transistor T₇. The second control signal line 232 is connected to the control end of the data writing transistor T₈, and is configured to input a second control signal to the control end of the data writing transistor T₈ to control the on and off of the data writing transistor T₈.

When the first control signal and the first scan signal are both active, the first scan signal controls the fifth transistor T₅ and the sixth transistor T₆ to be in an on state, and the first control signal controls the initialization transistor T₇ to be in the on state. The initialization signal is transmitted to the pixel circuit 110 through the initialization transistor T₇, and initializes the control end of the first pole plate and the first transistor T₁ of the capacitor C₁ through the sixth transistor T₆, such that the data can be written to the capacitor C₁. Meanwhile, the initialization signal initializes the anode of the light emitting diode D₁ through the fifth transistor T₅. It should be noted that the voltage of the initialization signal is lower than the voltage of the power source of the second power source V_{SS} to prevent the light emitting diode D₁ from emitting at the initialization stage.

When the second scan signal, the third scan signal and the second control signal are simultaneously active, the second scan signal controls the second transistor T₂ to be in the on state, the third scan signal controls the fourth transistor T₄ to be in the in the on state, the second control signal controls the data writing transistor T₈ to be in the on state, and the data signal is written to the second pole of the capacitor C₁ through the data writing transistor T₈ and the fourth transistor T₄.

When the third scan signal and the first control signal are both, the third scan signal controls the fourth transistor T₄ to be in the on state, the first control signal controls the initialization transistor T₇ to be in the on state, the initialization signal is applied to the control end of the first transistor T₁ through the capacitor C₁, and the supply voltage provided by the first power source V_{DD} is compensated, such that the current flowing through the first transistor T₁ is independent of the supply voltage of the first power source V_{DD}.

When the light emitting control signal is active, the light emitting control signal controls the third transistor T₃ to be in the on state, and the current flows through the light emitting diode D₁ to enable the light emitting diode D₁ to emit light.

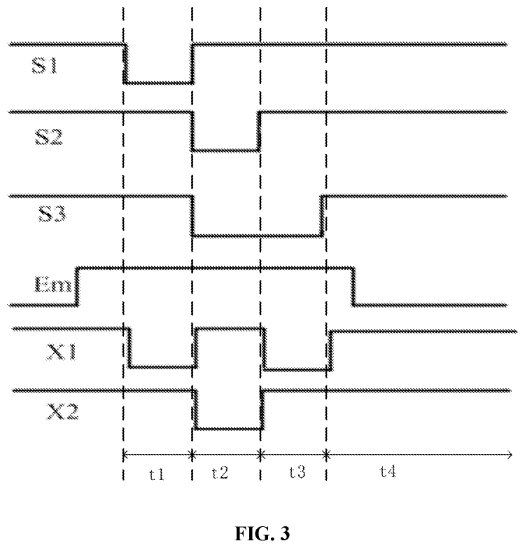

FIG. 3 is an operation sequence chart of the pixel circuit 110 according to an embodiment of the present disclosure. Based on FIGS. 2 and 3, the operating principle of the pixel circuit 110 is as follows:

In an initialization stage t1, the first scan signal and the first control signal are low-level signals, and the second scan signal, the third scan signal, the light-emitting control signal, and the second control signal are high-level signals. The initialization transistor T₇, the fifth transistor T₈ and the sixth transistor T₆ are switched on, and the data writing transistor T₈, the second transistor T₂, the third transistor T₃, and the fourth transistor T₄ are switched off.

Since the initialization transistor T₇ is switched on, the initialization signal enters the pixel circuit 110 through the transistor T₇ and the first signal line 120 connected to the transistor T₇. The initialization signal initializes the control end of the first transistor T₁ and the first pole plate of the capacitor C₁ through the sixth transistor T₆. The initialization signal may be, for example, the first reference voltage V_{ref}. The first reference voltage V_{ref} may be a negative voltage. The first reference voltage V_{ref} acts on the control end of the first transistor T₁ to switch on the first transistor T₁. Since the fifth transistor T₅ is switched on, the initialization signal can initialize the anode of the light emitting diode D₁.

In a data writing stage t2, the second scan signal, the third scan signal, and the second control signal are low-level signals, and the first scan signal, the first control signal, and the light-emitting control signal are high-level signals. The data writing transistor T₈, the second transistor T₂ and the fourth transistor T₄ are switched on, and in the initialization phase, the first transistor T₁ is switched on. The third transistor T₃, the fifth transistor T₅, the sixth transistor T₆ and the initialization transistor T₇ are switched off.

Because the first transistor T₁ is switched on, the power source voltage of the first power source V_{DD} is written to the first pole of the first transistor T₁. The voltage of the first pole of the first transistor T₁ continuously rises until the first transistor T₁ is in a critical state between off and on. At this time, the potential of the first pole of the first transistor T₁ is V_{DD}, and the potential of the control end is V_{DD}−|Vₜₕ|, thus compensating the threshold voltage of the first transistor T₁. Since the data writing transistor T₈ is switched on, the data signal enters the pixel circuit 110 through the data writing transistor T₈. Since the fourth transistor T₄ is switched on, the data signal is written to the second pole plate of the capacitor C₁ through the fourth transistor T₄, such that the potential of the second pole plate of the capacitor C₁ is V_{data}.

At compensation stage t3, the third scan signal and the first control signal are low level signals, the first scan signal, the second scan signal, the light emitting control signal, and the second control signal are high level signals, the fourth transistor T₄ and the initializing transistor T₇ are switched on, the second transistor T₂, the third transistor T₃, the sixth transistor T₆, the fifth transistor T₅ and the data writing transistor T₈ are switched off.

Since the initializing transistor T₇ is switched on, the initializing voltage is written to the second pole plate of the capacitor C₁ through the initializing transistor T₇ and the fourth transistor T₄, thus the potential of the second pole plate of the capacitor C₁ is changed from \Tama to V_{ref}. Since the second transistor T₂ and the sixth transistor T₆ are switched off, the voltage difference between the two ends of the capacitor C₁ remains unchanged. According to the principle of capacitance coupling, when the voltage difference of the capacitor C₁ remains unchanged, the potential of the first pole plate of the capacitor C₁ also changes with the change of the potential of the second pole plate. Since the control end of the first transistor T₁ is connected to the first pole plate of the capacitor C₁, the control end potential variation amount of the first transistor T₁ is V_{ref}−V_{data}. Therefore, the potential of the control end of the first transistor T₁ is V_{DD}−|Vₜₕ|+V_{ref}−V_{data}.

In a light emitting stage t4, the light emitting control signal is a low level signal, and the first scanning signal, the second scanning signal, the third scanning signal, the first control signal, and the second control signal are all high level signals. The third transistor T₃ is switched on, the second transistor T₂, the fourth transistor T₄, the sixth transistor T₆, the fifth transistor T₅, the initialization transistor T₇, and the data writing transistor T₈ are switched off. Since the third transistor T₃ is switched on, the circuit from the first power source V_{DD}, the first transistor T₁, the third transistor T₃, the light emitting diode D₁ to the second power source V_{SS} is switched on.

The current flowing through the first transistor T₁ is:

I=K*(V_{gs}−Vₜh)²=K*(V_{DD}−|V_{ref}−V_{data}−V_{DD}+|Vₜₕ|)²

=K*(V_{ref}−V_{data})

K=½*μ*Cₒₓ*W/L. μ is the electron mobility of the first transistor T₁, Cₒₓ is the gate oxide capacitance of the unit area of the first transistor T₁, W is the channel width of the first transistor T₁, and L is the channel length of the first transistor T₁. The driving current flowing through the first transistor T₁ is the light emitting current flowing through the light emitting diode D₁. It can be seen from the above formula that the light emitting current flowing through the light emitting diode D₁ is independent of the voltage of the first power source V_{DD}, the threshold voltage of the transistor, and dependent on the voltage value of the initialization signal. Therefore, according to the array substrate provided in the embodiments of the disclosure, the circuit structure of the array substrate can use the initialization signal to compensate a current-resistance voltage drop on a first power line. Meanwhile, the foregoing circuit structure and control method also compensate an influence of the threshold voltage to the luminous current, thereby improving the uniformity of luminous emission of the screen body. The array substrate data driving 220 is connected to the initialization transistor T₇ and the data writing transistor T₈ through the second signal line 221 and the third signal line 222, respectively. Different signals are transmitted through different signal lines, which makes it easy to control and prevents display failure. In the display area 100, both the initialization transistor T₇ and the data writing transistor T₈ input signals to the pixel circuit 110 through the first signal line 120, thereby reducing the tracing density of the screen body and further improving the resolution of the screen body.

It should be understood that, the data driving chip 220, the scan driving chip 230, and the light emitting control chip 240 may include at least one memory that stores a computer program and at least one processor that executes the computer program. The implementation of all or part of the process in the method of the above embodiment may be accomplished by hardware instructed by a computer program that may be stored in a non-temporary computer-readable storage medium. Embodiments of all the methods described above may be executed when a computer program is executed. Any reference to a memory, database or other medium used in the embodiments provided herein may include non-temporary and/or temporary memory. Non-volatile memory may include read-only memory (ROM), programmable ROM (PROM), electrically programmable ROM (EPROM), electrically erasable programmable ROM (EEPROM), or flash memory. Volatile memory may include random access memory (RAM) or external cache memory. RAM is available in various forms, such as static RAM (SRAM), dynamic RAM (DRAM), synchronous DRAM (SDRAM), double data rate SDRAM (DDRSDRAM), enhanced SDRAM (ESDRAM), synchronous link (Synchlink), DRAM (SLDRAM), Rambus direct RAM (RDRAM), direct memory bus dynamic RAM (DRDRAM), and memory bus dynamic RAM (RDRAM).

The foregoing respective technical features involved in the respective embodiments can be combined arbitrarily, for brevity, not all possible combinations of the respective technical features in the foregoing embodiments are described, however, to the extent they have no collision with each other, the combination of the respective technical features shall be considered to be within the scope of the description.

The foregoing implementations are merely specific embodiments of the present disclosure, and are not intended to limit the protection scope of the present disclosure. It should be noted that any variation or replacement readily figured out by persons skilled in the art within the technical scope disclosed in the present disclosure shall all fall into the protection scope of the present disclosure. Therefore, the protection scope of the present disclosure shall be subject to the protection scope of the claims.

1. An array substrate, comprising:
a display area having a plurality of pixel circuits arranged in an array and a first signal line connecting the pixel circuits; and
a non-display area arranged around the display area, the non-display area including:
a plurality of common circuits, wherein each of common circuits is connected to the plurality of pixel circuits through the first signal line, and is configured to provide an initialization signal and a data signal for the plurality of pixel circuits; and
a data driving chip connected to the plurality of common circuits through a second signal line and a third signal line, and configured to provide the initialization signal and the data signal for the plurality of common circuits.

2. The array substrate according to claim 1, wherein the plurality of common circuits comprises:
an initialization circuit connected to the data driving chip through the second signal line, and configured to receive the initialization signal outputted by the data driving chip and transmit the initialization signal to the pixel circuits through the first signal line; and
a data writing circuit connected to the data driving chip through the third signal line, and configured to receive the data signal outputted by the data driving chip and transmit the data signal to the pixel circuits through the first signal line.

3. The array substrate according to claim 2, wherein the non-display area further comprises a scan driving chip, and a first control signal line and a second control signal line connected to the scan driving chip;
the scan driving chip provides a first control signal to the initialization circuit through the first control signal line, such that the initialization circuit provides the initialization signal to the pixel circuits when the first control signal is active;
the scan driving chip provides a second control signal to the data writing circuit through the second control signal line, such that the data writing circuit provides the data signal to the pixel circuits when the second control signal is active.

4. The array substrate according to claim 3, wherein the scan driving chip is connected to the pixel circuits through a scan signal line, and configured to provide a scan signal to the pixel circuit.

5. The array substrate according to claim 3, further comprising a light emitting control chip connected to the pixel circuits through a light emitting control signal line, and configured to provide a light emitting control signal for the pixel circuits.

6. The array substrate according to claim 3, wherein the initialization circuit comprises an initialization transistor, a control end of the initialization transistor is connected to the scan driving chip through the first control signal line, a first pole of the initialization transistor is connected to the pixel circuits through the first signal line, and a second pole of the initialization transistor is connected to the data driving chip through the second signal line; and
the data writing circuit comprises a data writing transistor, a control end of the data writing transistor is connected to the scan driving chip through the second control signal line, a first pole of the data writing transistor is connected to the pixel circuits through the first signal line, and a second pole of the data writing transistor is connected to the data driving chip through the second signal line.

7. The array substrate according to claim 6, wherein the pixel circuits comprise a first transistor, a second transistor, a third transistor, a fourth transistor, a fifth transistor, a sixth transistor, a capacitor, and a light emitting diode;
a control end of the first transistor is connected to a first pole plate of the capacitor, a second pole of the second transistor, and a first pole of the sixth transistor, a first pole of the first transistor is connected to a first power source, and a second pole of the first transistor is connected to a first pole of the second transistor and a first pole of the third transistor;
a control end of the second transistor is connected to a second scanning signal line;
a control end of the third transistor is connected to a light emitting control signal line, a second pole of the third transistor is connected to a first pole of the fifth transistor and an anode of the light emitting diode, and a cathode of the light emitting diode is connected to a second power source;
a control end of the fifth transistor is respectively connected to a control end of the sixth transistor and a first scanning signal line, and a second pole of the fifth transistor is connected to a second pole of the sixth transistor, a second pole of the fourth transistor, the first pole of the initialization transistor, and the first pole of the data writing transistor; and
a control end of the fourth transistor is connected to a third scanning signal line, and a first pole of the fourth transistor is connected to a second pole plate of the capacitor.

8. The array substrate according to claim 7, wherein when the first control signal and the first scan signal are active simultaneously, the first control signal controls the initialization transistor to be switched on, the first scan signal controls the fifth transistor and the sixth transistor to be switched on, and the initialization signal initializes the first pole plate of the capacitor, the control end of the first transistor, and the anode of the light emitting diode.

9. The array substrate according to claim 8, wherein a voltage of the initialization signal is lower than a supply voltage of the second power source.

10. The array substrate according to claim 9, wherein when the third scan signal and the second control signal are active simultaneously, the third scan signal controls the fourth transistor to be switched on, the second control signal controls the data writing transistor to be switched on, and the data signal is written to the second pole of the capacitor through the data writing transistor and the fourth transistor.

11. The array substrate according to claim 10, wherein when the third scan signal and the first control signal are active simultaneously, the third scan signal controls the fourth transistor to be switched on, the first control signal controls the initialization transistor to be switched on, and the initialization signal is applied to the control end of the first transistor through the capacitor to compensate a supply voltage provided by the first power source.

12. The array substrate according to claim 11, wherein when the light emitting control signal is active, the light emitting control signal controls the third transistor to be switched on and the light emitting diode emits light.

13. A display panel comprising the array substrate according to claim 1.

14. A method for driving an array substrate, the method comprising:
providing, through a data driving chip, an initialization signal to a common circuit through a second signal line, and receiving, through the common circuit, the initialization signal and initializing a pixel circuit through a first signal line; and providing, through the data driving chip, a data signal to the common circuit through a third signal line, and receiving, through the common circuit, the data signal and writing data to the pixel circuit through the first signal line.

15. The method according to claim 14, wherein the common circuit comprises an initialization circuit and a data writing circuit, the initialization circuit is connected to the data driving chip through the second signal line, and the data writing circuit is connected to the data driving chip through the third signal line, and the method further comprises:
receiving, through the initialization circuit, an initialization signal outputted by the data driving chip and transmitting, through the first signal line, the initialization signal to the pixel circuit; and
receiving, through the data writing circuit, the data signal outputted by the data driving chip and transmitting the data signal to the pixel circuit through the first signal line.

16. The method according to claim 15, wherein a non-display region comprises a scan driving chip and a first control signal line and a second control signal line that are connected to the scan driving chip, and the method further comprises:
providing, through the scan driving chip, a first control signal to the initialization circuit through the first control signal line, and providing through the initialization circuit, the initialization signal to the pixel circuit when the first control signal is active; and
providing, through the scan driving chip, a second control signal to the data writing circuit through the second control signal line, and providing, through the data writing circuit, the data signal to the pixel circuit when the second control signal is active.

17. The method according to claim 16, wherein the scanning driving chip is connected to the pixel circuit through a scanning signal line, and the method further comprises:
providing, through the scan driving chip, a scan signal to the pixel circuit through a scan signal line.

18. The method according to claim 16, wherein the array substrate further comprises a light emitting control chip connected to the pixel circuit through a light emitting control signal line, and the method further comprises:
providing, through the light emitting control chip, a light emitting control signal for the pixel circuit through a light emitting control signal line.
